(19) United States
(12) Patent Application Publication
(10) Pub. No.: US 2024/0030497 A1
(43) Pub. Date: Jan. 25, 2024

(54) METHOD OF MANUFACTURING BATTERY

(71) Applicant: Prime Planet Energy & Solutions, Inc., Tokyo (JP)

(72) Inventors: Yoshihide ISOBE, Kobe-shi (JP); Shinobu OKAYAMA, Miyoshi-shi (JP)

(21) Appl. No.: 18/356,225

(22) Filed: Jul. 21, 2023

(30) Foreign Application Priority Data
Jul. 25, 2022 (JP) 2022-117901

(51) Int. Cl. H01M 10/0587; H01M 50/636

(52) U.S. Cl. CPC H01M 10/0587; H01M 50/636

(57) ABSTRACT

A method of manufacturing a battery is disclosed. The battery includes an electrode assembly including a positive electrode and a negative electrode, an electrolyte solution, and a battery case enclosing the electrode assembly and the electrolyte solution. The method includes an electrolyte filling step of filling the electrolyte solution into the battery case enclosing the electrode assembly, an X-ray applying step of applying X-rays to the battery case enclosing the electrode assembly and the electrolyte solution, and a checking step of checking a permeation state of the electrolyte solution in the electrode assembly based on an image obtained in the X-ray applying step. In the X-ray applying step, the tube current of an X-ray generator is higher than or equal to 100 μA and lower than or equal to 10000 μA.

### CROSS REFERENCE TO RELATED APPLICATIONS

The present application claims priority from Japanese Patent Application No. 2022-117901 filed on Jul. 25, 2022, which is incorporated by reference herein in its entirety.

### BACKGROUND

The present invention relates to a method of manufacturing a battery.

JP 2014-225373 discloses a method of filling an electrolyte solution for visualizing the impregnation state of an electrolyte solution. The electrolyte filling method disclosed in the publication includes a step of hermetically sealing a battery container into a hermetically sealed container, a step of bringing the interior of the hermetically sealed container into a high vacuum condition, a step of supplying a rare gas into the hermetically sealed container, and a step of filling and impregnating an electrolyte solution into the battery container. As examples of the rare gas, the publication lists krypton and xenon, which have higher atomic numbers than the main materials of the battery, such as iron. It should be noted that the electrolyte filling method disclosed in the publication is used in setting the pressure of high vacuum condition or the like of the electrolyte filling device, when, for example, changing the specification or producing the first lot of the battery.

The battery in which the electrolyte solution is filled by the just-described electrolyte filling method is checked using an X-ray CT system in a later inspection step, to check the impregnation state of the electrolyte solution. The X-ray CT system includes an X-ray generator, a rotational stage, and an X-ray detector. The battery is placed on the rotational stage in the X-ray CT system and irradiated with X-rays with it being rotated, to form a three-dimensional image. The three-dimensional image is subjected to a numerical analysis, to form arbitrary cross sectional multi-planar reconstruction images. This makes it possible to check an arbitrary cross section of the battery.

In the above-described electrolyte filling method, a rare gas is supplied to the interior of the hermetically sealed container before filling the electrolyte in the container. This means that the rare gas remains in the portion of the interior of the electrode assembly in which the electrolyte solution is not permeated. The X-ray absorption dose of the rare gas is greater than the X-ray absorption dose of the electrode assembly. Therefore, the portion containing the remaining rare gas absorbs a greater amount of X-rays, and that portion is displayed in white color in an X-ray CT image. As a result, it is possible to determine the amount of the remaining gas inside the battery. The publication states that it is possible to obtain a battery in which the amount of the remaining gas is small by setting the pressure of the hermetically sealed container in the high vacuum condition based on the amount of the remaining gas inside the battery.

### SUMMARY

From the viewpoint of battery performance, it is desirable that the electrolyte solution permeates sufficiently in the electrode assembly. However, productivity of the battery may be lowered if too long a time is allowed to permeate the electrode assembly with the electrolyte solution after filling the electrolyte solution into the battery case.

The present disclosure discloses a method of manufacturing a battery including an electrode assembly including a positive electrode and a negative electrode, an electrolyte solution, and a battery case enclosing the electrode assembly and the electrolyte solution. The method includes an electrolyte filling step of filling the electrolyte solution into the battery case enclosing the electrode assembly, an X-ray applying step of applying X-rays to the battery case enclosing the electrode assembly and the electrolyte solution, and a checking step of checking a permeation state of the electrolyte solution in the electrode assembly based on an image obtained in the X-ray applying step. In the X-ray applying step, the tube current of an X-ray generator is higher than or equal to 100 μA and lower than or equal to 10000 μA. The just-described manufacturing method enables the time for permeating the electrolyte solution into the electrode assembly to be set appropriately and improves productivity of battery manufacture.

### BRIEF DESCRIPTION OF THE DRAWINGS

FIG. 1 is a perspective view schematically illustrating a battery 100.

FIG. 2 is a schematic vertical cross-sectional view taken along line II-II in FIG. 1.

FIG. 3 is a perspective view schematically illustrating wound electrode assemblies 40 attached to a sealing plate 54.

FIG. 4 is a perspective view schematically illustrating a wound electrode assembly 40.

FIG. 5 is a schematic view illustrating the structure of the wound electrode assembly 40.

FIG. 6A is a schematic view illustrating a permeation state of an electrolyte solution 80 into the wound electrode assembly 40.

FIG. 6B is a schematic view illustrating a permeation state of the electrolyte solution 80 into the wound electrode assembly 40.

FIG. 6C is a schematic view illustrating a permeation state of the electrolyte solution 80 into the wound electrode assembly 40.

FIG. 7 is a schematic view illustrating an X-ray testing apparatus 200 and a battery case 50 that is to be tested.

FIG. 8 is a graph illustrating the relationship between transmitted X-ray intensity and thickness of the electrode assembly.

FIG. 9 is a schematic view illustrating division of an image.

FIG. 10A is a graph showing X-ray intensity.

FIG. 10B is a graph showing X-ray intensity.

FIG. 10C is a graph showing X-ray intensity.

### DETAILED DESCRIPTION

Hereinbelow, embodiments of the technology according to the present disclosure will be described with reference to the drawings. It should be noted, however, that the disclosed embodiments are, of course, not intended to limit the invention. The drawings are depicted schematically and do not necessarily accurately depict actual objects. The features and components that exhibit the same effects are designated by the same reference symbols as appropriate, and the description thereof will not be repeated as appropriate. It should be noted that the recitation of numerical ranges in the present description, such as “A to B”, is meant to include any values between the upper limits and the lower limits, inclusive, that is, “greater than or equal to A to less than or equal to B”.

In the drawings referred to in the present description, reference character X represents the axis along the depth, reference character Y represents the axis along the width, and reference character Z represents the axis along the height. Reference character F of the depth axis X represents “front”, and reference character Rr represents “rear”. As for the depth axis X, when a battery case is disposed in an X-ray testing apparatus, the direction in which the battery case faces an X-ray generator is defined as “front”, whereas the direction in which the battery case faces an X-ray detector is defined as “rear. Reference character L of the width axis Y represents “left” and reference character “R” represents “right”. Reference character U of the height axis Z represents “up” and reference character “D” represents “down”. These directional terms are defined merely for convenience in description, and are not intended to limit the arrangements and configurations of the secondary batteries disclosed herein when in use. In the present description, the term “battery” is intended to mean any electricity storage device in general that is capable of providing electric energy therefrom, which is intended to include primary batteries and secondary batteries. In the present description, the term “secondary battery” refers any electricity storage device in general in which repeated charging and discharging are possible by means of migration of charge carriers through an electrolyte between a pair of electrodes (positive electrode and negative electrode). The term “secondary battery” is also intended to encompass what is called storage batteries, such as lithium-ion secondary batteries and nickel-metal hydride batteries, as well as capacitors, such as electric double-layer capacitors. Hereinbelow, embodiments that use lithium-ion secondary batteries will be described.

In an embodiment according to the present disclosure, a method of manufacturing a battery includes an electrolyte filling step, an X-ray applying step, and a checking step. In this embodiment, the method of manufacturing a battery includes a preliminary X-ray application step prior to the electrolyte filling step. Hereinafter, an embodiment of the method of manufacturing a battery will be described along with the configuration of the battery.

### Battery 100

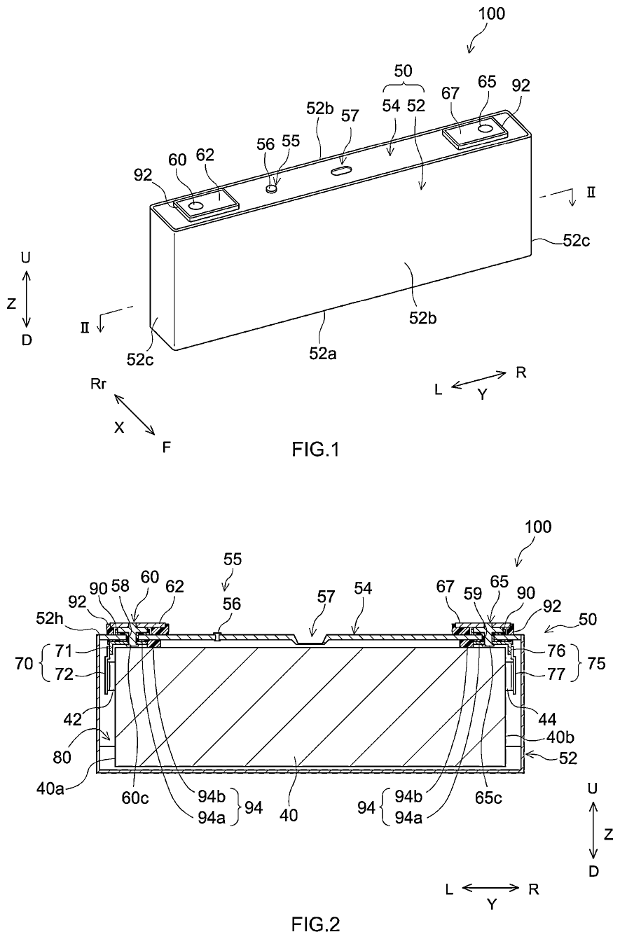

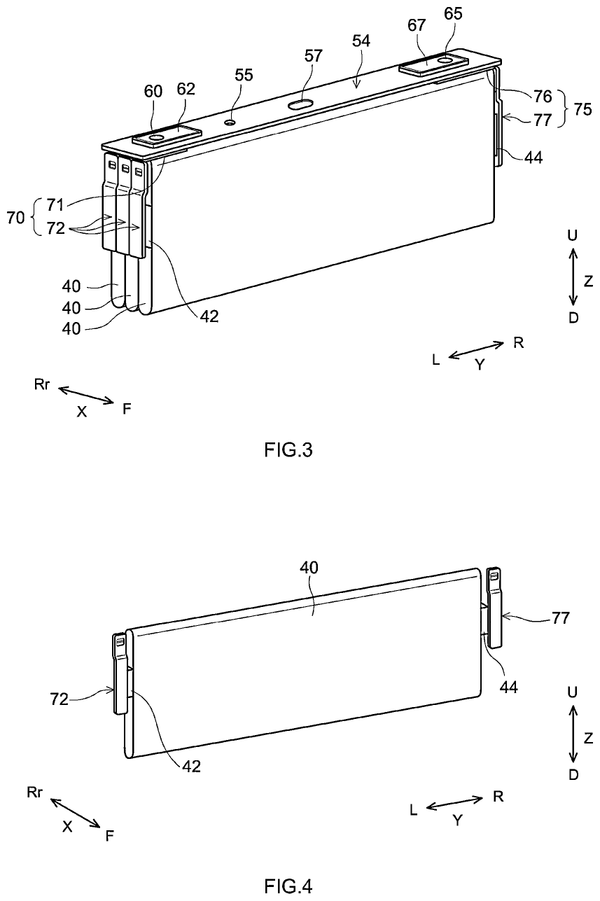

A method of manufacturing a battery disclosed herein manufactures a battery 100, which includes an electrode assembly 40, an electrolyte solution 80, and a battery case 50. FIG. 1 is a perspective view schematically illustrating the battery 100. FIG. 2 is a schematic vertical cross-sectional view taken along line II-II in FIG. 1. FIG. 3 is a perspective view schematically illustrating wound electrode assemblies 40 attached to a sealing plate 54. FIG. 4 is a perspective view schematically illustrating a wound electrode assembly 40. As illustrated in FIG. 2, in the battery 100, the electrode assembly 40 and the electrolyte solution 80 are enclosed in the battery case 50.

In manufacturing a battery, the battery case 50, which encloses the electrode assembly 40 including a positive electrode and a negative electrode, may be prepared first. The configurations of the electrode assembly 40 and the battery case 50 are not limited to any particular configuration.

In this embodiment, the battery case 50 has an outer shape of a flat and closed-bottom rectangular parallelepiped shape (i.e., a prismatic shape). The battery case 50 includes an outer container 52 and a sealing plate 54. The outer container 52 includes a flat, substantially rectangular bottom wall 52a, a pair of first side walls 52b extending upward along the height axis Z from longer sides of the bottom wall 52a, and a pair of second side walls 52c extending upward along the height axis Z from shorter sides of the bottom wall 52a (see FIG. 1). The height of the first side walls 52b and the height of the second side walls 52c are substantially the same. The area of the first side walls 52b is larger than that of the other side walls (the second side walls 52c in this embodiment). In this embodiment, a plurality of (three in this embodiment) wound electrode assemblies 40 (see FIG. 3), serving as the electrode assembly 40, are disposed inside the battery case 50. The wound electrode assemblies 40 are enclosed in the battery case 50 in such a manner that they are aligned along the depth axis X of the battery 100.

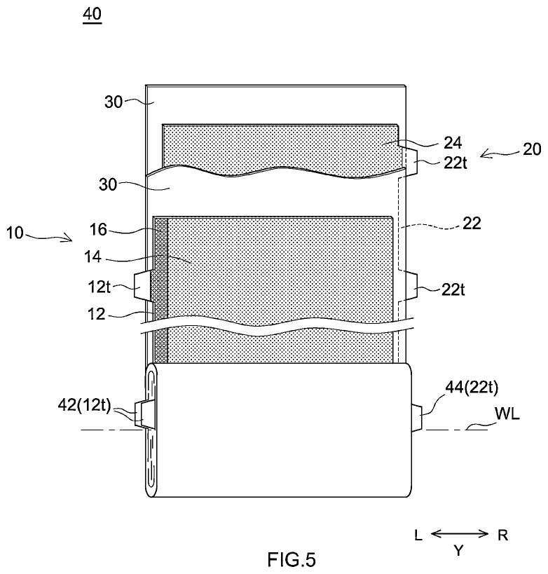

FIG. 5 is a schematic view illustrating the structure of the wound electrode assembly 40. As illustrated in FIG. 5, the wound electrode assembly 40 is a flat electrode assembly in which a positive electrode plate 10 and a negative electrode plate are stacked with separators 30 interposed therebetween and wound about a winding axis WL. The configurations of the wound electrode assembly 40 and the battery case will be described later in detail.

After preparing the battery case 50 in which the wound electrode assembly 40 is enclosed, filling of the electrolyte solution 80 is carried out next. In this embodiment, prior to an electrolyte filling step of filling the electrolyte solution 80, a preliminary X-ray applying step is provided for obtaining X-ray data to be used in a later-described checking step.

### Preliminary X-Ray Applying Step

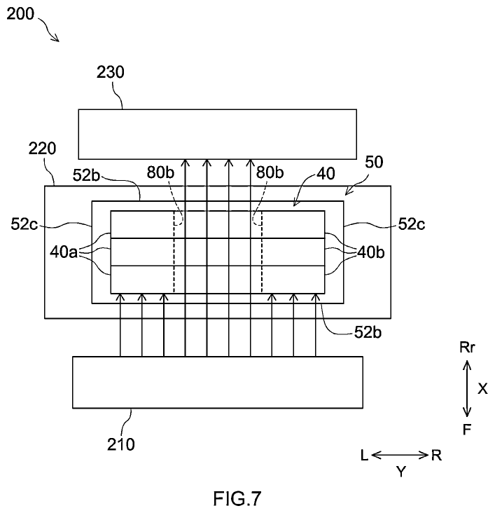

The preliminary X-ray applying step involves applying X-rays to the battery case in which the electrode assembly 40 is enclosed before the electrolyte solution 80 is filled. The preliminary X-ray applying step and a later-described X-ray applying step are performed in an X-ray testing apparatus 200 (see FIG. 7).

In the preliminary X-ray applying step, X-rays are applied to the battery case 50 in which the electrolyte solution 80 has not yet been filled in the X-ray testing apparatus 200 (see FIG. 7) under the same conditions as in the later-described X-ray applying step, so that X-ray data are obtained. For example, the testing conditions such as the position at which the battery case 50 is placed, the output power of the X-ray generator 210 (see FIG. 7), and the time for which an image is captured may be the same before and after the filling of the electrolyte solution 80. The details of the X-ray testing apparatus 200 and the conditions for the X-ray application will be described later.

After the preliminary X-ray applying step, the battery case 50 is moved to a chamber for filling the electrolyte solution 80, which is not shown in the drawings, and the electrolyte solution 80 is filled.

### Electrolyte Filling Step

The electrolyte filling step involves filling the electrolyte solution 80 into the battery case 50 in which the electrode assembly 40 is enclosed. For the electrolyte solution 80, it is possible to use any conventionally known electrolyte solution commonly used for secondary batteries without any particular restriction. As the electrolyte solution 80, for example, it is possible to use a non-aqueous electrolyte solution in which a supporting salt is dissolved in a non-aqueous solvent. Examples of the non-aqueous solvent include carbonate-based solvents, such as ethylene carbonate, dimethyl carbonate, and ethyl methyl carbonate. Examples of the supporting salt include fluorine-containing lithium salts, such as LiPF₆. The electrolyte solution 80 may contain various types of additive agents, such as a gas generating agent, a surface film forming agent, a dispersing agent, and a thickening agent, as necessary.

Inside a chamber, not shown, the electrolyte solution 80 may be filled into the battery case 50. A vacuum pump for depressurizing the interior of the chamber may be connected to the chamber. First, the battery case 50 is housed into the chamber. Next, the interior of the chamber is adjusted to be a predetermined depressurized condition. Next, the electrolyte solution 80 is filled into the battery case 50 with an electrolyte filling nozzle, not shown, being inserted in a filling port 55 (see FIG. 2) of the battery case 50.

Upon filling the electrolyte solution 80 into the battery case 50, the electrolyte solution 80 starts to permeate into the electrode assembly 40. Filling the electrolyte solution 80 into the battery case 50 under a depressurized environment allows the electrolyte solution 80 to easily permeate into the electrode assembly 40. As a result, the time until permeation of the electrolyte solution 80 into the electrode assembly 40 is completed can be reduced. Note that the atmosphere in which the electrolyte solution 80 is filled into the battery case 50 is not limited to any particular atmosphere. The chamber may be configured so that air, an inert gas such as nitrogen, or the like can be introduced into the chamber.

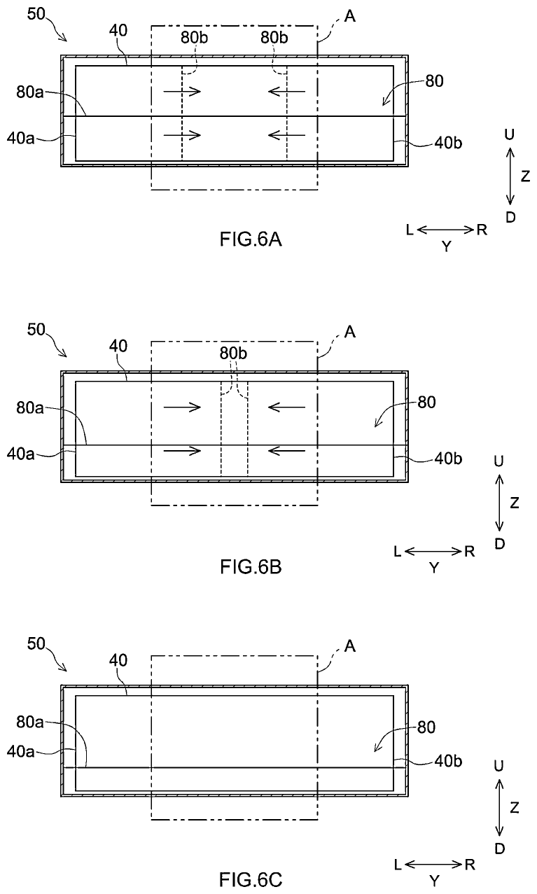

In the wound electrode assembly 40, the positive electrode plate 10, the negative electrode plate 20, and the separators 30 are wound and stacked on each other except for both side surfaces 40a and 40b (see FIG. 6) along the winding axis WL. For this reason, the electrolyte solution 80 does not easily permeate into the electrode assembly 40 in a direction perpendicular to the winding direction of the winding axis WL. On the other hand, the longer side edges of the strip-shaped positive electrode plate 10 and the strip-shaped negative electrode plate 20 that have been wound are located at the side surfaces 40a and 40b of the wound electrode assembly 40. Therefore, the electrolyte solution 80 easily permeates into the wound electrode assembly 40 from the side surfaces 40a and 40b inwardly along the winding axis WL.

After filling the electrolyte solution 80, the battery case 50 is allowed to stand still for a predetermined wait time. The wait time may be, for example, an expected time for the electrolyte solution 80 to permeate into the central portion of the wound electrode assembly 40 after completion of filling of the electrolyte solution 80. The wait time may be set through, for example, pretesting. In this embodiment, the wait time is set to, but not particularly limited to, 50 hours.

FIG. 6 shows schematic views each illustrating a permeation state of the electrolyte solution 80 into the wound electrode assembly 40. FIG. 6 schematically shows how the electrolyte solution 80 permeates into the electrode assembly 40 as time passes after the electrolyte filling. FIG. 6A shows the battery case 50 in the middle of the process in which the electrolyte solution 80 permeates into the electrode assembly 40. FIG. 6B shows the battery case 50 in which the electrolyte solution 80 has not yet been permeated completely. FIG. 6C shows the battery case 50 in which the electrolyte solution 80 has been permeated completely. In FIGS. 6A and 6B, the directions in which the electrolyte solution 80 permeates are indicated by arrows. In FIGS. 6A to 6C, the constituent components of the battery 100 except for the battery case 50, the wound electrode assembly 40, and the electrolyte solution 80 are not depicted. In FIG. 6, an image capturing region A in which X-ray data are obtained in the later-described X-ray applying step is indicated by dash-dot-dot line.

As illustrated in FIG. 6, the electrolyte solution 80 permeates into the electrode assembly 40 as time passes. In the wound electrode assembly 40, a boundary 80b between a region permeated with the electrolyte solution 80 (hereinafter also referred to as a “permeated region”) and a region not permeated with the electrolyte solution 80 (hereinafter also referred to as a “non-permeated region”) moves inward from the side surfaces 40a and 40b at both edges of the wound electrode assembly 40. In the non-permeated region with the electrolyte solution 80 within the wound electrode assembly 40, a gas corresponding to the atmosphere of the interior of the battery case 50 remains. As the electrolyte solution 80 gradually permeates into the wound electrode assembly 40, the non-permeated region (i.e., the region in which the gas is contained) decreases accordingly. Also, as the electrolyte solution 80 gradually permeates into the wound electrode assembly 40, the liquid level 80a of the electrolyte solution 80 lowers accordingly.

After the wait time has passed, the interior of the chamber is released to atmospheric pressure, and the battery case 50 is taken out. The filling port 55 (see FIG. 2) of the battery case 50 may be fitted with a rubber plug or the like for temporary sealing. The battery case 50 that has been taken out is subsequently transferred to an X-ray testing apparatus 200 (see FIG. 6).

### X-Ray Applying Step

In the X-ray applying step, X-rays are applied to the battery case 50 in which the electrode assembly 40 and the electrolyte solution 80 are enclosed. FIG. 7 is a schematic view illustrating the X-ray testing apparatus 200 and the battery case 50 to be tested. In this embodiment, the X-ray testing apparatus 200 is a transmission X-ray apparatus that detects transmission of X-rays that are applied to a testing object from a predetermined direction. In FIG. 7, the directions in which X-rays are applied are indicated by arrows. As illustrated in FIG. 7, the X-ray testing apparatus 200 includes an X-ray generator 210, a stage 220, and an X-ray detector 230. The X-ray generator 210, the stage 220 and the X-ray detector 230 are enclosed in a container, not shown, for shielding X-rays.

The X-ray generator 210 is a device that generates X-rays. The X-ray generator 210 may be an X-ray tube that generates X-rays by causing electrons to which high voltage is applied to collide with a metal. The X-ray source may be an X-ray source that can deal with a tube voltage of from 100 kV to 300 kV. The X-ray source is used in this case may be either a closed tube or an open tube. Although not particularly limited thereto, this embodiment employs an X-ray tube that uses beryllium as a target.

The X-ray detector 230 is a detector device that detects the X-rays generated from the X-ray generator 210 and transmitted through the battery case 50. Preferable examples of the X-ray detector 230 may include a detector that is capable of converting detected X-ray data into image data, such as a flat panel detector or an image intensifier. Although not limited thereto, it is preferable that image capturing time (imaging time) may be set to about 0.5 seconds to about 500 seconds.

The stage 220 is positioned between the X-ray generator 210 and the X-ray detector 230. A battery case 50 to be tested is placed on the stage 220. The stage 220 may also include a securing member, not shown, for securing the battery case 50. With the securing member, the battery case 50 can be tested at substantially a constant position. It is preferable that the securing member may be provided at a position at which it does not hinder application of X-rays to the battery case 50; for example, the securing member may be configured to retain the battery case 50 from a direction substantially perpendicular to the direction in which the X-rays are applied. The stage 220 may be configured to be able to adjust its position and angle. By adjusting the position and angle of the stage 220, the region of the battery case 50 to be tested may be adjusted.

It is also possible that a jig for adjusting the intensity of the X-rays according to the intensity of the X-rays applied to the X-ray detector 230 may be provided between the X-ray generator 210 and the X-ray detector 230. The jig may be a flat-shaped shielding that is able to shield a region of the X-ray detector 230 to which X-rays are applied. For the jig, it is possible to use, for example, stainless steel, copper, lead, or the like. The jig may be disposed between the X-ray generator 210 and the battery case 50, or may be disposed between the X-ray detector 230 and the battery case 50. Because the jig is provided between the X-ray generator 210 and the X-ray detector 230, irregular reflection of the X-rays entering the X-ray detector 230 is prevented. Therefore, the intensity of the X-rays is adjusted, and halation is unlikely to occur in the obtained image data. Moreover, because the jig is provided between the X-ray generator 210 and the X-ray detector 230, deterioration of the X-ray detector 230 is prevented.

The battery case 50 is disposed on the stage 220 with the bottom wall 52a (see FIG. 1) facing downward. In this embodiment, the X-ray generator 210 is disposed facing one of the first side walls 52b and the X-ray detector 230 is disposed facing the other one of the first side walls 52b. In other words, the battery case 50 is disposed on the stage 220 so that the one of the first side walls 52b faces the X-ray generator 210 while the other one of the first side walls 52b faces the X-ray detector 230. Thus, X-rays may be applied substantially perpendicularly to the first side walls 52 having a larger area than other side walls (the second side walls 52c in this case) of the battery case By applying and detecting X-rays from a wider surface (i.e., the first side wall 52b) of the battery case 50, it is possible to check permeation of the electrolyte solution 80 along the wider surface. This makes it easier to check the permeation state of the electrolyte solution 80 into electrode assembly 40.

Moreover, this embodiment employs the wound electrode assembly 40 as the electrode assembly 40. The applying direction of X-rays is set to be substantially perpendicular to the winding axis WL. This means that the applying direction of X-rays is set to be substantially perpendicular to the direction in which the electrolyte solution 80 permeates. Thus, the applying direction of X-rays is set to be substantially perpendicular to the winding axis WL so the position of the electrolyte solution 80 that is permeating from the side surfaces 40a and 40b toward the central portion of the wound electrode assembly 40 can be observed easily.

In this embodiment, the position of the battery case 50 is set to be a position such that a rectangular region in 105 mm length (Z axis) and 150 mm width (Y axis) centered about the center of the first side wall 52b can be imaged. It should be noted that the imaging capturing region of the battery case 50 is not particularly limited, and may be set as appropriate depending on the dimensions of the battery case 50 and the configuration of the electrode assembly 40 enclosed therein. In this embodiment, the image capturing region A is set to be wider than the height of the battery case 50 and narrower than the width of the battery case 50 (see FIG. 6).

The intensity of the X-rays generated from the X-ray generator 210 may be adjusted by the tube current. When the tube current is higher, the intensity of the X-rays generated from the X-ray generator 210 is accordingly higher, while when the tube current is lower, the intensity is accordingly lower. When the tube current is lower, the amount of the X-rays transmitting through the battery case 50 is smaller, which may cause the contrast of the detected image to lower. From the viewpoint of improving the contrast between the region through which X-rays transmit more easily and the region through which X-rays transmit less easily (i.e., X-rays are absorbed or reflected), it is preferable that the X-ray generator generate a higher tube current. From such a viewpoint, the tube current of the X-ray generator may preferably be set to higher than or equal to 100 μA, more preferably higher than or equal to 1000 μA, even more preferably higher than or equal to 2000 μA, or may be set to higher than or equal to 3000 μA. On the other hand, when the tube current is too high, the amount of the X-rays detected by the X-ray detector 230 is too large, which may cause halation to occur. From such a viewpoint, the tube current of the X-ray generator may preferably be set to lower than or equal to 10000 μA, more preferably lower than or equal to 7000 μA, even more preferably lower than or equal to 4500 μA, or may be set to lower than or equal to 4000 μA. This may allow the detected image to lessen a decrease of contrast due to halation.

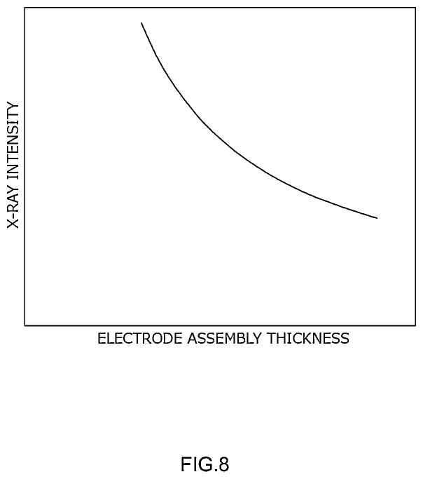

FIG. 8 is a graph illustrating the relationship between transmitted X-ray intensity and thickness of the electrode assembly. FIG. 8 shows the relationship between the thickness of the electrode assembly and the intensity of X-rays that have been applied at a constant intensity, transmitted through the electrode assembly and detected by an X-ray detector. As illustrated in FIG. 8, the amount of transmitted X-rays changes according to the thickness of the wound electrode assembly. When the thickness of the wound electrode assembly is greater, the amount of X-ray transmission is less, while when the thickness of the wound electrode assembly is less, the amount of X-ray transmission is greater. The amount of X-ray transmission also changes according to the weight of the wound electrode assembly. When the weight of the wound electrode assembly is heavier, the amount of X-ray transmission is less, while when the weight of the wound electrode assembly is lighter, the amount of X-ray transmission is greater. Therefore, the appropriate value of the tube current is different from one battery to another.

When the tube current is higher, the energy of the X-rays is accordingly higher, while when the tube current is lower, the energy of the X-rays is accordingly lower. It is preferable that the tube voltage applied to the X-ray generator 210 be set to higher than or equal to 100 kV, or may be set to higher than or equal to 150 kV. The tube voltage applied to the X-ray generator 210 may preferably be set to lower than or equal to 300 kV. In addition, the energy required for X-rays to penetrate the wound electrode assembly changes according to the thickness of the wound electrode assembly. When the thickness of the wound electrode assembly is greater, the energy required for X-rays to penetrates the wound electrode assembly is higher, while the thickness of the wound electrode assembly is less, the energy required for X-rays to penetrates the wound electrode assembly is lower. Therefore, the appropriate value of the tube voltage is different from one battery to another.

The X-ray generator 210 generates X-rays having a wavelength of about 1 pm to about 10 nm. Herein, the time for which X-rays are emitted from the X-ray generator 210 to the battery case 50 may be set to about 1 second to about 60 seconds. The X-ray detector 230 detects the X-rays emitted from the X-ray generator 210 and transmitted through the battery case 50. The X-ray data detected by the X-ray detector 230 are X-ray data that are obtained from one direction. An image that is obtained based on the just-mentioned X-ray data enables checking of permeation of the electrolyte solution 80 into the electrode assembly 40 within the battery case 50. It should be noted that the conditions concerning X-ray generation are not limited to the above-described conditions.

### Checking Step

The checking step involves checking a permeation state of the electrolyte solution 80 in the electrode assembly 40 based on an image obtained in the X-ray applying step. In the wound electrode assembly 40, a permeated region shows a higher X-ray attenuation than a non-permeated region. For this reason, the non-permeated region shows a higher X-ray intensity detected by the X-ray detector 230 than the permeated region. By checking the X-ray intensity of the image, the permeation state of the electrolyte solution 80 can be checked. Note that the checking of the permeation state of the electrolyte solution 80 may be performed by, for example, an image processing device or the like.

The image processing device may set an X-ray intensity threshold value for distinguishing between a permeated region and a non-permeated region. The X-ray intensity threshold value for distinguishing between a permeated region and a non-permeated region may be set, for example, through a method of performing pre-testing using a battery case and an electrolyte solution that have the same configurations as those of the battery case and the electrolyte solution that are to be tested.

When there is no region that shows an X-ray intensity higher than the threshold value, it is determined that permeation of the electrolyte solution 80 has been completed, and the battery case 50 is transferred to a subsequent manufacturing step. When the region that shows an X-ray intensity higher than the threshold value is small, it is determined likewise that permeation of the electrolyte solution 80 is nearly completed, and the battery case 50 may be transferred to a subsequent manufacturing step. Before the battery case 50 is transferred to the subsequent manufacturing step, the filling port 55 is plugged with a sealing member 56 (see FIG. 2) to seal the battery case 50. Note that when to seal the filling port 55 is not particularly limited.

When the region that shows an X-ray intensity higher than the threshold value is large, it means that permeation of the electrolyte solution 80 requires more time, so the wait time is extended. The area of the region or the like for determining whether or not permeation of the electrolyte solution 80 is completed may be set through pre-testing.

The X-ray data obtained in the X-ray applying step may be affected by the components that constitute the battery 100, such as the battery case 50 and the electrode assembly 40. In order to check the permeation state of the electrolyte solution 80 with high accuracy, it is desired to reduce the adverse effects from the components that constitute the battery 100 other than the electrolyte solution 80. In this embodiment, in the checking step, a background removing process is performed from a result obtained by the X-ray applying step using a result obtained by the preliminary X-ray applying step. Based on the result obtained through the background removing process, the permeation state of the electrolyte solution 80 is determined.

As described previously, the preliminary X-ray applying step obtains X-ray data obtained by applying X-rays to the battery case 50 in which the electrolyte solution 80 has not yet been filled under the same conditions as in the X-ray applying step. Accordingly, the X-ray data obtained in the preliminary X-ray applying step may be such X-ray data in which the components other than the electrolyte solution 80 are removed. Using such X-ray data in executing the background removing process may enable the permeation state of the electrolyte solution 80 to be able to be checked more accurately. In addition, the constituent components of the battery case 50 and the wound electrode assembly 40 may have product variations in such as thickness. Such product variations may appear in the form of shade or the like in X-ray data. Using X-ray data before and after the filling of the electrolyte solution 80 makes it possible to obtain X-ray data in which the shades or the like due to product variations are reduced, so that the permeation state of the electrolyte solution 80 may be checked more accurately. Such advantageous effects are achieved irrespective of X-ray applying conditions, such as the tube current.

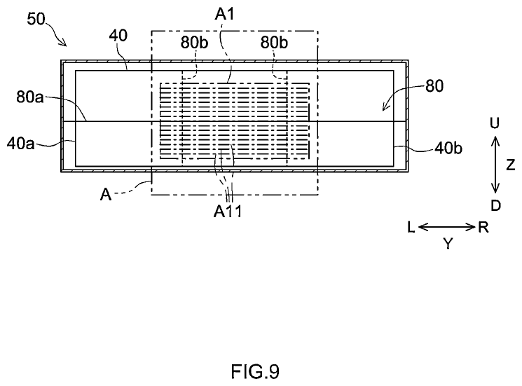

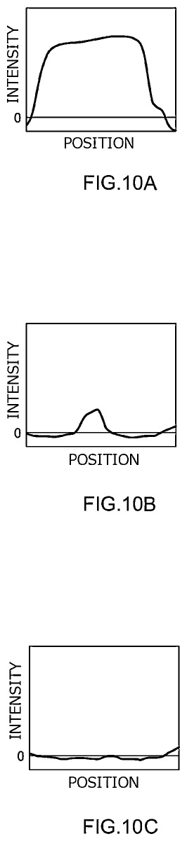

In this embodiment, an image obtained in the X-ray applying step is divided into a plurality of portions along the winding axis WL of the wound electrode assembly 40. The divided portions of the image are superimposed on each other. Whether or not the permeation of the electrolyte solution 80 has been completed is determined based on the superimposed image. FIG. 9 is a schematic view illustrating division of an image. FIG. 9 schematically shows an example of a dividing pattern of an image obtained from the battery case 50 in the state of FIG. 6A. In FIG. 9, the boundaries between divided portions of the image are indicated by dot-dashed lines. FIG. 10 shows graphs illustrating X-ray intensity. FIG. 10 shows graphs each illustrating X-ray intensity obtained by dividing an image as shown in FIG. 9, for the battery case 50 with a permeation state of the electrolyte solution 80 shown in FIG. 9. FIGS. 10A to 10C correspondingly show graphs of X-ray intensity obtained from the data of battery cases 50 in respective states shown in FIGS. 6A to 6C.

In this embodiment, as illustrated in FIG. 9, the image obtain in the X-ray applying step is divided into a plurality of portions. The image is divided into a plurality of portions along the winding axis WL (the axis Y) of the wound electrode assembly 40. Dividing of the image may be executed by an image processing program. Herein, data of a region A1, which is smaller than the image capturing region A, are used. The image of the region A1 is divided into a plurality of image portions A11. The width of each of the divided image portions A11 is not limited to a particular width but may be adjusted in units of pixels. The plurality of image portions A11 are obtained at respective different heights. Each of the image portions A11 contains X-ray intensity data corresponding to positions on the width axis Y. A plurality of image portions A11 are superimposed on each other to thereby obtain data in which X-ray intensities are integrated for each of the positions on the width axis Y (see FIG. 10). Whether or not permeation of the electrolyte solution 80 has been completed may be determined by, for example, whether or not the intensity after the background removing process is higher than a predetermined threshold value.

The integrating of the data may improve the contrast between the region in which the electrolyte solution 80 has permeated and the region in which the electrolyte solution 80 has not yet permeated. For example, even when the imaging time is short, it is possible to obtain images with good contrast. For this reason, the imaging time in the X-ray applying step reduces, improving the productivity of manufacture of the battery 100. It should be noted that the direction in which an image is divided is not limited to the foregoing embodiment, but may be set as appropriate depending on the configuration of the battery 100, the direction in which the enclosed electrolyte solution 80 permeates, or the like.

If it is determined that permeation of the electrolyte solution 80 has been completed, an initial charging process and an aging process are performed using known techniques, and the battery 100 is manufactured.

In the above-described embodiment, the method of manufacturing a battery includes an electrolyte filling step, an X-ray applying step, and a checking step. In the X-ray applying step, the tube current of an X-ray generator is higher than or equal to 100 μA and lower than or equal to 10000 μA. Because the tube current is set to such a high value, the contrast of the image obtained in the X-ray applying step increases, so that the permeation state of the electrolyte solution 80 into electrode assembly 40 can be checked easily. In addition, such a high contrast image can be obtained by imaging from one direction using a transmission X-ray device. As a result, it is possible to check permeation of the electrolyte solution 80 in short time. Because the time required for checking permeation of the electrolyte solution 80 is reduced, the efficiency in producing the battery 100 may be improved. Moreover, because the testing is carried out using X-ray irradiation, permeation of the electrolyte solution 80 can be checked in a non-destructive manner.

Furthermore, since the tube current is set to a high value, the method may also be adopted for a battery 100 that has a structure that does not transmit X-rays easily. Moreover, in this embodiment, the electrode assembly 40 includes a plurality of wound electrode assemblies 40 aligned along the depth axis X of the battery case 50. When there are many barriers (wound electrode assemblies 40 herein) along the direction in which X-rays are applied, the X-rays are likely to be attenuated easily, and the detected intensity of X-rays tends to be lower. However, this embodiment sets the tube current to a high value and is therefore likely to be able to keep the intensity of the X-rays transmitting through the plurality of wound electrode assemblies 40 at a sufficiently high value easily. This enables permeation of the electrolyte solution 80 to be checked easily with high accuracy.

In the above-described embodiment, data of the battery case 50 before the electrolyte filling are obtained in the preliminary X-ray applying step, and data of the battery case 50 after the electrolyte filling are obtained in the X-ray applying step. However, such embodiments are merely illustrative. For example, the preliminary X-ray applying step may be performed by applying X-rays to a battery case 50 and an electrode assembly 40 that have been prepared for the testing. Alternatively, the preliminary X-ray applying step may be performed by applying X-rays to a test specimen, such as a metal plate. In the case where the preliminary X-ray applying step is performed using a test specimen, the test specimen may be selected so that the attenuation of X-rays due to the test specimen will be approximately the same as the attenuation due to the battery case 50 and the electrode assembly 40. In such a case as well, the attenuation caused by the components other than the electrolyte solution 80 is reduced, so the permeation state of the electrolyte solution 80 can be checked more accurately.

Examples of the configurations of the electrode assembly 40 and the battery case 50 that constitute the battery 100 manufactured according to the above-described manufacturing method will be described below. It should be noted that the battery 100 manufactured by the technology disclosed herein is of course not limited to the following embodiments.

### Battery Case 50

The battery case 50 may be made of any conventionally known material without any particular restriction. The battery case 50 may be, for example, made of a metal. Examples of the material for the battery case 50 may include aluminum, aluminum alloys, iron, and iron alloys. Although not particularly limited thereto, the battery case 50 may preferably be made of aluminum or an aluminum alloy.

The sealing plate 54 of the battery case 50 is a plate-shaped member in a substantially rectangular shape viewed in plan. As illustrated in FIG. 2, the sealing plate 54 is a member that closes an opening 52h of the outer container 52. The sealing plate 54 is provided with a filling port 55 and a gas vent valve 57. The filling port 55 is a through hole provided for filling the electrolyte solution 80 into the interior of the battery case 50. The gas vent valve 57 is a thinned portion that is designed to rupture (i.e., to open) when a large amount of gas is generated inside the battery case 50, so as to expel the gas. The sealing plate 54 is formed with terminal insertion holes 58 and 59 to which respective electrode terminals are fitted. The terminal insertion holes 58 and 59 are formed at respective end portions of the width axis Y of the sealing plate 54.

### Electrode Terminals

A positive electrode terminal 60 is attached to one end portion of the sealing plate 54 along the width axis Y of the battery 100. The positive electrode terminal 60 is connected to a plate-shaped positive electrode external conductive member 62 outside the battery case 50. On the other hand, a negative electrode terminal 65 is attached to the other end portion of the sealing plate 54 along the width axis Y of the battery 100. The negative electrode terminal 65 is connected to a plate-shaped negative electrode external conductive member 67 outside the battery case 50. These external conductive members (i.e., the positive electrode external conductive member 62 and the negative electrode external conductive member 67) are connected to other secondary batteries and external devices via an external connecting member (such as a bus bar).

A positive electrode first current collector 71 and a negative electrode first current collector 76 are attached to an inner surface of the sealing plate 54. Each of the positive electrode first current collector 71 and the negative electrode first current collector 76 is a plate-shaped conductive member extending along the inner surface of the sealing plate 54. A lower end 60c of the positive electrode terminal 60 is connected to the positive electrode first current collector 71. A lower end 65c of the negative electrode terminal 65 is connected to the negative electrode first current collector 76.

### Insulating Member

The sealing plate 54 is provided with various insulating members that prevent electrical conduction between the battery case 50 (i.e., the outer container 52 and the sealing plate 54) and the electrode terminals (i.e., the positive electrode terminal 60 and the negative electrode terminal 65). Each of the terminal insertion holes 58 and 59 in the sealing plate 54 is fitted with a gasket that prevents electrical conduction between the electrode terminals and the sealing plate 54. An outer insulating member 92 is disposed between the positive electrode external conductive member 62 (or the negative electrode external conductive member 67) and the outer surface of the sealing plate 54. An inner insulating member 94 is disposed between the positive electrode first current collector 71 (or the negative electrode first current collector 76) and the inner surface of the sealing plate 54. The inner insulating member 94 includes a plate-shaped base portion 94a attached to the inner surface of the sealing plate 54. The inner insulating member 94 incudes a protruding portion 94b protruding from the base portion 94a toward the wound electrode assembly 40. The protruding portion 94b restricts later-described upward and downward movements of the electrode assembly 40 to prevent the electrode assembly 40 and the sealing plate 54 from coming into direct contact with each other. The material for the above-described insulating members is not limited to any particular material as long as the material has predetermined insulating capability. Examples of the insulating member may include synthetic resin materials, such as polyolefin-based resins and fluorine-based resins.

### Electrode Assembly 40

As illustrated in FIG. 5, the electrode assembly 40 is a wound electrode assembly 40 including the positive electrode sheet 10, the negative electrode sheet 20, and separators 30. It should be noted that the electrode assembly is not limited to such a wound electrode assembly. It is also possible that the electrode assembly may be, for example, a stacked electrode assembly in which a plurality of rectangular positive electrode plates and a plurality of rectangular negative electrode plates are alternately stacked on each other with separators interposed therebetween.

Positive Electrode Plate 10

The positive electrode plate 10 is an oblong strip-shaped member. The positive electrode plate 10 includes a positive electrode substrate 12, which is a metal member in a foil shape, and a positive electrode active material layer 14, which is formed on a surface of the positive electrode substrate 12. From the viewpoint of battery performance, the positive electrode active material layer 14 may preferably be formed on both surfaces of the positive electrode substrate 12. A positive electrode tab 12t protruding outward (leftward in FIG. 7) along the axis Y is provided on one side edge of the positive electrode plate 10. A plurality of the positive electrode tabs 12t are provided along the longitudinal axis of the positive electrode plate 10 so as to be spaced at predetermined intervals. Each of the positive electrode tabs 12t is not provided with the positive electrode active material layer 14 or a protective layer 16 so that the positive electrode substrate 12 is exposed therefrom.

For the positive electrode substrate 12, it is possible to use a metal material having predetermined electrical conductivity. It is more preferable that the positive electrode substrate 12 be made of, for example, aluminum or an aluminum alloy.

The positive electrode active material layer 14 is a layer containing a positive electrode active material. The positive electrode active material is a material that is able to reversibly absorb and release charge carriers in relation to the later-described negative electrode active material. The positive electrode active material is not limited to any particular material. For the positive electrode active material, it is possible to use, for example, lithium-transition metal composite oxides.

The positive electrode active material layer 14 may contain additive agents, other than the positive electrode active material. The positive electrode active material layer 14 may contain a binder. A suitable example of the binder may be a resin binder. Suitable examples of the resin binder may include, for example, polyvinylidene fluoride (PVDF). The positive electrode active material layer 14 may preferably contain a conductive agent. Suitable examples of the conductive agent include carbon materials such as acetylene black (AB).

A protective layer 16 may be provided, as necessary, on one side edge portion of the positive electrode plate 10. The protective layer 16 is a layer configured to show a lower electrical conductivity than the positive electrode active material layer 14. The protective layer 16 is provided on the positive electrode substrate 12 at a position facing the negative electrode active material layer 24 across the separator 30. Although the configuration of the protective layer 16 is not particularly limited, the protective layer 16 may be, for example, a layer coated with a resin or a layer containing inorganic particles or a binder.

### Negative Electrode Plate 20

The negative electrode plate 20 is an oblong strip-shaped member. The negative electrode plate 20 includes a negative electrode substrate 22, which is a metal member in a foil shape, and a negative electrode active material layer 24, which is formed on a surface of the negative electrode substrate 22. From the viewpoint of battery performance, the negative electrode active material layer 24 may preferably be formed on both surfaces of the negative electrode substrate 22. A negative electrode tab 22t protruding outward (rightward in FIG. 13) along the axis Y is provided on one side edge of the negative electrode plate 20. The negative electrode tab 22t protrudes in the opposite direction to the above-described positive electrode tab 12t. A plurality of the negative electrode tabs 22t are provided along the longitudinal axis of the negative electrode plate 20 so as to be spaced at predetermined intervals. Each of the negative electrode tabs 22t is not provided with the negative electrode active material layer 24 so that the negative electrode substrate 22 is exposed therefrom.

For the negative electrode substrate 22, it is possible to use a metal material having predetermined electrical conductivity. It is more preferable that the negative electrode substrate 22 be made of, for example, copper or a copper alloy.

The negative electrode active material layer 24 is a layer containing a negative electrode active material. The negative electrode active material is a material that is able to reversibly absorb and release charge carriers in relation to the positive electrode active material. The negative electrode active material is not limited to any particular material. Suitable examples of the negative electrode active material include, for example, carbon materials, silicon based materials, and composite oxides thereof. Examples of the carbon materials may include graphite, hard carbon, soft carbon, and amorphous carbon. Examples of the silicon based materials include silicon and silicon oxide (silica).

The negative electrode active material layer 24 may contain additive agents, other than the negative electrode active material. The negative electrode active material layer 24 may contain a binder as an additive agent. A suitable example of the binder is a resin binder. Examples of the resin binder may include styrene-butadiene rubber (SBR), carboxymethylcellulose (CMC), and polyacrylic acid (PAA), for example. The negative electrode active material layer 24 may preferably contain a conductive agent. Suitable examples of the conductive agent include carbon materials, such as acetylene black (AB) and carbon nanotubes.

The width of each of the positive electrode active material layer 14 and the negative electrode active material layer 24 (i.e., the length along the winding axis WL) is not limited to any particular width. The width of the negative electrode active material layer 24 may be formed to be slightly wider than the width of the positive electrode active material layer 14. From the viewpoint of battery performance, it is preferable that the dimensions of the positive electrode active material layer 14 of the positive electrode plate 10 and the dimensions of the negative electrode active material layer 24 of the negative electrode plate 20 be greater. From the viewpoint of battery performance, the width of the positive electrode active material layer 14 (i.e., the length along the winding axis WL) may preferably be greater than or equal to 20 cm, more preferably greater than or equal to 25 cm. From the viewpoint that the electrolyte solution 80 is allowed to permeate to the central portion of the wound electrode assembly 40, the width of the positive electrode active material layer 14 may preferably be less than or equal to 50 cm, more preferably less than or equal to 40 cm. Such a battery 100 with a greater width may require longer time for permeation of the electrolyte solution 80. The technology disclosed herein may also be suitably applied to the manufacture of such a battery 100 with a greater width.

### Separator 30

The separator 30 is an oblong strip-shaped member that has the function to prevent the positive electrode plate 10 and the negative electrode plate 20 from coming into contact and also to allow charge carriers to pass therethrough. The width of the separator 30 may be set to a size such as to be able to cover the positive electrode active material layer 14 of the positive electrode plate 10 and the negative electrode active material layer 24 of the negative electrode plate 20.

The separator 30 may preferably use a porous resin film in which a plurality of micropores allowing charge carriers to pass through. The resin sheet constituting the separator 30 may also be formed with a heat resistant layer and an adhesive layer. The heat resistant layer is a layer that exhibits excellent heat resistance. It is preferable that the heat resistant layer contain ceramic particles and a binder. For the ceramic particles, it is possible to use, for example, alumina or the like. The adhesive layer is a layer that exhibits excellent adhesiveness with the electrode plates (i.e., the positive electrode plate and the negative electrode plate 20). The adhesive layer may contain a binder, such as polyvinylidene fluoride (PVdF). The adhesive layer may also contain ceramic particles.

### Wound Electrode Assembly 40

The wound electrode assembly 40 is manufactured from the positive electrode plate 10, the negative electrode plate 20, and the separator 30 that are described above. The wound electrode assembly 40 may be manufactured, for example, in the following manner. First, an oblong strip-shaped positive electrode plate 10 and an oblong strip-shaped negative electrode plate 20 are stacked with oblong strip-shaped separators interposed therebetween, to form a laminated stack. Next, the laminated stack is coiled along the longitudinal axis to prepare a cylindrical wound stack. Here, the positive electrode plate 10, the negative electrode plate 20, and the separators 30 are coiled with their positions being aligned so that a plurality of positive electrode tabs 12t and a plurality of negative electrode tabs 22t can be respectively overlapped at respective predetermined positions. This allows the cylindrical wound stack to be provided with a positive electrode tab group 42 and a negative electrode tab group 44.

Subsequently, the cylindrical wound stack is pressed. This prepares a flat-shaped wound electrode assembly 40. Herein, each of the separators 30 is provided with a surface layer. For this reason, the separators 30 have good adhesiveness with the positive electrode plate 10 and the negative electrode plate 20. This makes it possible to prepare a wound electrode assembly 40 that is wound and pressed with the distance between the positive electrode plate 10 and the negative electrode plate 20 being maintained appropriately.

Although the dimensions of the pressed wound electrode assembly 40 are not particularly limited, the height of the pressed wound electrode assembly 40 may preferably be greater than or equal to 5 cm, more preferably greater than or equal to 8 cm, along the Z axis. The height of the pressed wound electrode assembly 40 may preferably be less than or equal to 15 cm, more preferably less than or equal to 12 cm, along the Z axis. The length of the wound electrode assembly 40 along the winding axis WL (for example, the width of the separators 30) may preferably be greater than or equal to 1.5 times, more preferably greater than or equal to 2 times, the height of the wound electrode assembly 40. The battery 100 including such a wound electrode assembly 40 that is elongated along the winding axis WL may require a longer time for the electrolyte solution 80 to permeate to the central portion of the wound electrode assembly 40. The technology disclosed herein may also be suitably applied to the manufacture of such a battery 100 including a wound electrode assembly 40 that is elongated along the winding axis WL.

It should be noted that the number of windings and the dimensions of the wound electrode assembly 40 may be adjusted as appropriate taking into consideration the performance and efficiency of manufacture of the battery 100 to be produced. Although not limited thereto, it is preferable that the positive electrode plate 10 and the negative electrode plate 20 be wound so that greater than or equal to 20 layers each are stacked along the X axis. It is more preferable that greater than or equal to 33 layers of the positive electrode plate 10 be stacked. It is more preferable that greater than or equal to 35 layers of the negative electrode plate 20 be stacked. In such a battery 100 with a large number of windings, the electrolyte solution 80 does not easily permeate inward from its outside, but easily permeates inward in a direction along the winding axis WL of the wound electrode assembly 40. The technology disclosed herein may also be suitably applied to the manufacture of such a battery 100 with a large number of windings.

When the wound electrode assembly 40 is prepared, a positive electrode second current collector 72 and a negative electrode second current collector 77 are respectively connected to the positive electrode tab group 42 and the negative electrode tab group 44, as illustrated in FIG. 4. As illustrated in FIG. 3, the upper end of the positive electrode second current collector 72 is electrically connected to the positive electrode first current collector 71, and the upper end of the negative electrode second current collector 77 is electrically connected to the negative electrode first current collector 76. The positive electrode first current collector 71 and the positive electrode second current collector 72 constitute a positive electrode current collector 70. The negative electrode first current collector 76 and the negative electrode second current collector 77 constitute a negative electrode current collector 75.

In this embodiment, a plurality of wound electrode assemblies 40 are housed in the outer container 52 with their being attached to the sealing plate 54. The number of the wound electrode assemblies 40 is not limited to any particular number. The plurality of wound electrode assemblies 40 are attached to the sealing plate 54 so that their winding axes WL are substantially parallel to each other. The axial direction of the winding axis WL of each wound electrode assembly 40 is set to be along the first side walls 52b. In this embodiment, the wound electrode assemblies 40 are housed in the battery 100 so that the winding axis WL and the width axis Y of the battery 100 are substantially in agreement with each other. Note that the plurality of wound electrode assemblies 40 may be housed in the battery case 50 so that they are covered with an electrode assembly holder, not shown, which is made of an electrically insulative resin sheet. The electrode assembly holder may be formed of, for example, polypropylene (PP). Because the electrode assemblies 40 are housed in the battery case 50 with their being covered with the electrode assembly holder, the electrode assemblies 40 and the outer container 52 are prevented from coming into direct contact and making electrical conduction.

Various embodiments of the technology according to the present disclosure have been described hereinabove. Unless specifically stated otherwise, the embodiments described herein do not limit the scope of the present invention. It should be noted that various other modifications and alterations may be possible in the embodiments of the technology disclosed herein. In addition, the features, structures, or steps described herein may be omitted as appropriate, or may be combined in any suitable combinations, unless specifically stated otherwise.

As has been described above, the present description contains the following disclosure, which includes the following items.

Item 1: A method of manufacturing a battery including an electrode assembly including a positive electrode and a negative electrode, an electrolyte solution, and a battery case enclosing the electrode assembly and the electrolyte solution, the method including: an electrolyte filling step of filling the electrolyte solution into the battery case enclosing the electrode assembly; an X-ray applying step of applying X-rays to the battery case enclosing the electrode assembly and the electrolyte solution; and a checking step of checking a permeation state of the electrolyte solution in the electrode assembly based on an image obtained in the X-ray applying step, wherein in the X-ray applying step, a tube current of an X-ray generator is set to higher than or equal to 100 μA and lower than or equal to 10000 μA.

Item 2: The method according to item 1, wherein in the checking step, the image obtained in the X-ray applying step is divided into a plurality of portions along a predetermined direction, and the divided portions of the image are superimposed on each other, to determine the permeation state of the electrolyte solution based on the superimposed portions of the image.

Item 3: The method according to item 1 or 2, further including a preliminary X-ray applying step of applying X-rays to the battery case prior to the electrolyte filling step, and wherein in the checking step, a background removing process is performed from a result obtained by the X-ray applying step using a result obtained by the preliminary X-ray applying step.

Item 4: The method according to any one of items 1 to 3, wherein: the battery case includes a pair of first side walls; each of the first side walls has a larger area than another side wall; and the X-ray applying step is performed with the X-ray generator disposed facing one of the first side walls and the X-ray detector disposed facing the other one of the first side walls.

Item 5: The method according to any one of items 1 to 4, wherein the electrode assembly includes a plurality of wound electrode assemblies disposed in the battery case.

What is claimed is:

1. A method of manufacturing a battery including an electrode assembly including a positive electrode and a negative electrode, an electrolyte solution, and a battery case enclosing the electrode assembly and the electrolyte solution, the method comprising:
an electrolyte filling step of filling the electrolyte solution into the battery case enclosing the electrode assembly;
an X-ray applying step of applying X-rays to the battery case enclosing the electrode assembly and the electrolyte solution; and
a checking step of checking a permeation state of the electrolyte solution in the electrode assembly based on an image obtained in the X-ray applying step, wherein
in the X-ray applying step, a tube current of an X-ray generator is set to higher than or equal to 100 μA and lower than or equal to 10000 μA.

2. The method according to claim 1, wherein in the checking step, the image obtained in the X-ray applying step is divided into a plurality of portions along a predetermined direction, and the divided portions of the image are superimposed on each other, to determine the permeation state of the electrolyte solution based on the superimposed portions of the image.

3. The method according to claim 1, further comprising:
a preliminary X-ray applying step of applying X-rays to the battery case prior to the electrolyte filling step, and wherein
in the checking step, a background removing process is performed from a result obtained by the X-ray applying step using a result obtained by the preliminary X-ray applying step.

4. The method according to claim 1, wherein:
the battery case includes a pair of first side walls;
each of the first side walls has a larger area than another side wall; and
the X-ray applying step is performed with the X-ray generator disposed facing one of the first side walls and the X-ray detector disposed facing the other one of the first side walls.

5. The method according to claim 1, wherein the electrode assembly includes a plurality of wound electrode assemblies disposed in the battery case.
